(19) United States
(12) Patent Application Publication
(10) Pub. No.: US 2025/0201818 A1
(43) Pub. Date: Jun. 19, 2025

(54) CATHODE ACTIVE MATERIAL, LITHIUM-ION SECONDARY BATTERY, AND METHOD FOR PRODUCING CATHODE ACTIVE MATERIAL

(71) Applicant: TOYOTA JIDOSHA KABUSHIKI KAISHA, Toyota-shi (JP)

(72) Inventors: Takahiko NINOMIYA, Miyoshi-shi (JP); Hiroo NOZAKI, Chiryu-shi (JP); Ryosuke OHSAWA, oKAZAKI-SHI (JP); Taku KINOSHITA, Toyota-shi (JP)

(73) Assignee: TOYOTA JIDOSHA KABUSHIKI KAISHA, Toyota-shi (JP)

(21) Appl. No.: 18/895,809

(22) Filed: Sep. 25, 2024

(30) Foreign Application Priority Data
Dec. 15, 2023 (JP) 2023-212418

(51) Int. Cl. H01M 4/36; H01M 4/02; H01M 4/38; H01M 10/0525

(52) U.S. Cl. CPC H01M 4/366; H01M 4/382; H01M 10/0525; H01M 2004/028

(57) ABSTRACT

The present disclosure relates to a cathode active material, a lithium-ion secondary battery, and a method for producing the cathode active material. The cathode active material includes a dopant element M1 and a dopant element M2, in which a transition-metal layer containing nickel and a lithium layer are alternately arranged crystal structure, and an ionic radii ratio represented by M1/M2 is 1.03 or more and 2.2 or less.

### CROSS-REFERENCE TO RELATED APPLICATION

This application claims priority to Japanese Patent Application No. 2023-212418 filed on Dec. 15, 2023, incorporated herein by reference in its entirety.

### BACKGROUND

### 1. Technical Field

The present disclosure relates to a cathode active material, a lithium-ion secondary battery, and a method for producing the cathode active material.

### 2. Description of Related Art

A lithium transition metal composite oxide having a layered crystal structure in which a transition metal layer made up of an octahedral structure made up of a transition metal and oxygen, and a lithium layer, are alternately disposed, is widely used as a cathode active material for lithium-ion secondary batteries.

As the lithium transition metal composite oxide having the layered crystal structure, one is known that contains, as the transition metal, at least one type selected from nickel, cobalt and manganese (e.g., see Japanese Unexamined Patent Application Publication No. 2019-23149 (JP 2019-23149 A)).

### SUMMARY

Among lithium transition metal composite oxides having a layered crystalline structure, those containing nickel as a transition metal are suitable as cathode active materials for large-capacity lithium-ion secondary batteries for use as batteries in battery electric vehicles. On the other hand, an ongoing problem with lithium-ion secondary batteries using a cathode active material containing nickel as the transition metal is reduction in resistance.

An object of the present disclosure is to provide a cathode active material including nickel as a transition metal with reduced resistance in a lithium-ion secondary battery, a lithium-ion secondary battery including a cathode containing the cathode active material, and a method for producing the cathode active material.

Solutions of the above object include the following aspects.
1

A cathode active material includes
a crystal structure in which a transition metal layer containing nickel, and a lithium layer, are disposed alternatingly, in which
a dopant element M1 and a dopant element M2 with an ionic radii ratio represented by M1/M2 of 1.03 or more and 2.2 or less are included.
2

In the cathode active material according to 1, the ionic radii ratio of the dopant element M1 and of the dopant element M2 as to nickel are each 0.7 or more and 2.3 or less.
3

In the cathode active material according to 1 or 2, the dopant element M1 and the dopant element M2 are each selected from a group consisting of Sn, Y, Pr, La, Sr, Ta, W, Fe and Nb.
4

A lithium-ion secondary battery including a cathode containing the cathode active material according to any one of 1 to 3.
5

A method for producing a cathode active material including a crystal structure in which a transition metal layer containing nickel, and a lithium layer, are disposed alternatingly, includes
adding, to the cathode active material, a dopant element Ml and a dopant element M2 with an ionic radii ratio represented by M1/M2 of 1.03 or more and 2.2 or less.

According to an embodiment of the present disclosure, a cathode active material including nickel as a transition metal with reduced resistance in a lithium-ion secondary battery, a lithium-ion secondary battery including a cathode containing the cathode active material, and a method for producing the cathode active material, are provided.

### DETAILED DESCRIPTION OF EMBODIMENTS

In the present disclosure, numerical ranges specified herein with “A-B,” “between A and B,” “(from) A to B,” etc., represent ranges, which include the minimum A and the maximum B.

In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples.
In the present disclosure, the term “step” is included in the term as long as the intended purpose of the step is achieved, even if it is not clearly distinguishable from other steps as well as independent steps.
In the present disclosure, a combination of two or more preferred embodiments is a more preferred embodiment.
In the present disclosure, the amount of each component means the total amount of a plurality of substances unless otherwise specified, when a plurality of substances corresponding to each component are present.

### Cathode Active Material

The cathode active material of the present disclosure includes:
a crystal structure in which a transition metal layer containing nickel, and a lithium layer, are disposed alternatingly, in which
a dopant element M1 and a dopant element M2 with an ionic radii ratio represented by M1/M2 of 1.03 or more and 2.2 or less are included.

The cathode active material of the present disclosure is a compound belonging to a lithium transition metal complex oxide having a crystal structure (also referred to as a layered laminated structure or a R-3m type crystal structure) in which transition metal layers and lithium layers are alternately arranged. The transition metal layer is formed of an octahedral structure composed of a transition metal and oxygen.

In the present disclosure, the lithium transition metal composite oxide means a composite oxide including lithium and one or more transition metals.
The ionic radii ratio represented by M1/M2 means a value obtained by dividing the ionic radius of the dopant element M1 by the ionic radius of the dopant element M2.

A lithium-ion secondary battery using a cathode active material containing a dopant element M1 and a dopant element M2 having an ionic radii ratio represented by M1/M2 of 1.03 or more and 2.2 or less is shown in the embodiments described below. This lithium-ion secondary battery has a lower resistance than a lithium-ion secondary battery using a cathode active material that does not satisfy the above-described conditions. The reason for this is inferred as follows, for example. However, the present disclosure is not limited by the following inference.

In a lithium-ion secondary battery using a lithium transition metal composite oxide having a layered crystal structure as a cathode active material, lithium ions are desorbed from a lithium layer disposed between transition metal layers during charging. In the lithium-ion secondary battery, lithium ions are inserted into the lithium layer during discharge.

When the transition metal layer contains the dopant element M1 and the dopant element M2 having an ionic radii ratio of 1.03 or more and 2.2 or less, the position of oxygen in the transition metal layer changes, and the octahedral structure shrinks to widen the lithium layer. As a result, it is considered that desorption or insertion of lithium ions in the lithium layer is facilitated, and the resistance of the battery is reduced.

From the viewpoint of effectively reducing the resistivity of the batteries, the ionic radii ratio represented by M1/M2 are preferably 1.1 or more, more preferably 1.3 or more, and still more preferably 1.5 or more.

From the viewpoint of effectively reducing the resistivity of the batteries, the ionic radii ratio represented by M1/M2 are preferably 2.0 or less, more preferably 1.8 or less, and still more preferably 1.7 or less.

The type of the dopant element included in the transition-metal layer is not particularly limited, and examples thereof include Au, Bi, Hf, La, Mo, Nb, Pd, Pr, Rh, Pt, Sr, Ta, Tc, Ti, W, Y, Zr, and the like.

Preferred examples of the dopant element include Y (ionic radius: 0.69 Å), La (ionic radius: 1.03 Å), Nb (ionic radius: 0.72 Å), and W (ionic radius: 0.62 Å). Preferred examples of the dopant element include Sr (ionic radius: 1.18 Å), Pr (ionic radius: 0.99 Å), and Fe (ionic radius: 0.55 Å).
The type of the dopant element contained in the cathode active material may be two or three or more.

From the viewpoint of effectively reducing the resistivity of the cell, the dopant elements M1 and M2 preferably have an ionic radii ratio (M1 or M2/Ni) of 0.7 to 2.3 with respect to the ion radius (0.56 Å) of Ni, respectively.

The total content of the dopant element M1 and the dopant element M2 included in the transition-metal layers is not particularly limited.

The total content of the dopant element M1 and the dopant element M2 contained in the transition metal layer may be 0.005 mol % or more with respect to the total of the transition metal and the dopant element contained in the cathode active material.

From the viewpoint of balancing the properties of the cathode active material, the total content of the dopant element M1 and the dopant element M2 contained in the transition metal layer may be 1 mol % or less, or 0.1 mol % or less with respect to the total of the transition metal and the dopant element contained in the cathode active material. Alternatively, from the viewpoint of balancing the properties of the cathode active material, the total content of the dopant element M1 and the dopant element M2 contained in the transition metal layers may be 0.05 mol % or less with respect to the total of the transition metal and the dopant element contained in the cathode active material.
The molar ratios of the dopant element M1 and the dopant element M2 included in the transition-metal layers are not particularly limited. From the viewpoint of sufficiently obtaining the effectiveness of reducing the resistivity of the cell, the molar ratio of the dopant element Ml and the dopant element M2 (M1/M2) is preferably within the scope of 0.5 to 2.0

The cathode active material of the present disclosure includes at least nickel as a transition metal.

From the viewpoint of balance of characteristics of the cathode active material, it is more preferable that the cathode active material contains nickel as a transition metal and at least one selected from cobalt and manganese. Further, from the viewpoint of balancing the properties of the cathode active material, it is more preferable that the cathode active material contains nickel, cobalt, and manganese as transition metals (NCM, nickel cobalt manganese oxide).

NCM may contain a high proportion of Ni (e.g., 50 mol % or more, 60 mol % or more, or 70 mol % or more of the total transition-metal).

The molar ratio of Ni, Co and Mn contained in NCM may be selected, for example, from the molar ratio (Ni:Co) of Ni to Co in the range of 1:0.1 to 1:1, and the molar ratio (Ni:Mn) of Ni to Mn in the range of 1:0.1 to 1:1.

The molar ratio (Ni:Co) of Ni to Co may be selected from 1:0.1 to 1:0.5, 1:0.1 to 1:0.3, or 1:0.1 to 1:0.2.

The molar ratio (Ni:Mn) of Ni to Mn may be selected from 1:0.1 to 1:0.5, 1:0.1 to 1:0.3, or 1:0.1 to 1:0.2.

The cathode active material may be in particulate form. The volume average particle diameter of the cathode active material in a particulate form is not particularly limited, and can be selected from, for example, a range of 5 μm to 30 μm. When the cathode active material is a secondary particle that is an aggregate of a plurality of primary particles, the volume average particle diameter is the volume average particle diameter of the secondary particles.

The volume average particle diameter of the cathode active material particles is not particularly limited, and can be selected, for example, from the range of 5 μm to 30 μm.

The volume-average particle size of the particles is the particle size (D50) when the cumulative volume is 50% in the volume-based particle size distribution. The volume-based particle size distribution is obtained, for example, by a laser diffraction and scattering method.

### Lithium-Ion Secondary Battery

The lithium-ion secondary battery of the present disclosure includes a cathode including the above-described cathode active material.

The cathode includes, for example, a current collector and a cathode layer disposed on the current collector, and the cathode layer includes the cathode active material of the present disclosure.
The cathode layer may be disposed on one side or both sides of the current collector.

Examples of the material constituting the current collector of the cathode include aluminum, an aluminum alloy, nickel, titanium, and stainless steel. Examples of the shape of the current collector include a foil and a mesh.

The cathode layer is disposed on the current collector by, for example, applying a slurry-like cathode material to one or both surfaces of the current collector. If necessary, a pressure treatment for adjusting the density of the cathode layer may be performed. The thickness of the cathode layer is not particularly limited, and can be selected from, for example, a range of 10 μm to 100 μm.

The cathode material may be in a state of a mixture containing components other than the cathode active material, such as a conductive aid and a binder. If desired, a solvent may be added to the mixture to adjust the viscosity of the mixture.

Specific examples of the conductive aid include carbon materials such as carbon black (acetylene black, thermal black, furnace black, and the like), carbon nanotubes, and graphite.

The conductive material contained in the cathode material may be one kind alone or two or more kinds thereof.

Specific examples of the binder include polyvinylidene fluoride (PVDF), polyethylene, polypropylene, polyethylene terephthalate, cellulose, nitrocellulose, carboxymethylcellulose, and polyethylene oxide. Specific examples of the binder include polyepichlorohydrin, polyacrylonitrile, styrene-butadiene rubber (SBR), acrylonitrile-butadiene rubber (NBR), polyacrylates, and polymethacrylates.

The binder contained in the cathode material may be one kind alone or two or more kinds thereof.

The lithium-ion secondary battery of the present disclosure includes, for example, a cathode, a negative electrode, and an electrolyte.

The negative electrode includes, for example, a current collector and a negative electrode layer disposed on the current collector and including a negative electrode active material. Examples of the negative electrode active material include carbon materials such as graphite, hard carbon, soft carbon, and activated carbon, silicon, metallic lithium, lithium alloy, and lithium titanate (LTO).
Examples of the material constituting the current collector of the negative electrode include copper, a copper alloy, nickel, titanium, and stainless steel. Examples of the shape of the current collector of the negative electrode include a foil and a mesh.

The electrolyte may be either a liquid or a solid. As the liquid electrolyte (electrolyte solution), a solution obtained by dissolving a known electrolyte such as LiPF₆ in an organic solvent can be used without any particular limitation.

Specific examples of the organic solvents include cyclic or linear carbonates such as ethylene carbonate (EC), dimethyl carbonate (DMC), diethyl carbonate (DEC), and ethyl methyl carbonate (EMC). The solvent may be a mixture of two or more solvents or a mixture comprising a cyclic carbonate and a linear carbonate.
Solvents may include additives such as vinylene carbonate (VC).
As the solid electrolyte, a known solid electrolyte such as a sulfide solid electrolyte, an oxide solid electrolyte, or a halide solid electrolyte can be used without any particular limitation.

The lithium-ion secondary battery may include a separator disposed between the cathode and the negative electrode. Examples of the separator include a nonwoven fabric, a cloth, and a microporous film containing a polyolefin as a main component, such as polyethylene and polypropylene.

A method for producing a cathode active material, the method comprising

A method for producing a cathode active material according to the present disclosure includes:

A method for producing a cathode active material including a crystal structure in which a transition metal layer containing nickel, and a lithium layer, are disposed alternatingly, includes
A dopant element M1 and a dopant element M2 having an ionic radii ratio of M1/M2 of 1.03 or more and 2.2 or less are added to the cathode active material.

The dopant element M1 and the dopant element M2 having an ionic radii ratio of M1/M2 of 1.03 to 2.2 are added to the cathode active material. That is, the cathode active material includes a dopant element M1 and a dopant element M2 having an ionic radii ratio of M1/M2 of 1.03 or more and 2.2 or less.

A lithium-ion secondary battery using a cathode active material including a dopant element M1 and a dopant element M2 having an ionic radii ratio represented by M1/M2 of 1.03 to 2.2 is shown in the embodiments described below. The lithium-ion secondary battery has a lower resistivity than a lithium-ion secondary battery using a cathode active material that does not include a dopant element M1 and a dopant element M2 having an ionic radii ratio of M1/M2 of 1.03 or more and 2.2 or less.

Conditions for carrying out the disclosed methods are not particularly limited except for adding the dopant element M1 and the dopant element M2 having an ionic radii ratio of M1/M2 of 1.03 or more and 2.2 or less to the cathode active material, and may be known conditions.

The method of the present disclosure may be, for example, a method including a step of calcining a mixture including a compound including a transition metal as a raw material of a cathode active material, a compound including lithium, and a compound including a dopant element.
Examples of the compound containing a transition metal, lithium, or a dopant element include hydroxides, carbonates, and oxides. The compound containing a transition metal may be a composite compound containing two or more transition metals.

The temperature at which the firing step is performed is not particularly limited, and can be selected from known firing conditions. The temperature of the firing may be selected, for example, from the range of 600° C. to 850° C.

The temperature at which the firing step is performed may be constant or varied from the start to the end of the firing step.
The calcination step can be performed, for example, in an atmosphere having an oxygen content of 40 vol % to 100 vol %.
The temperature or oxygen content during the firing step may be constant or varied from the start to the end of the firing step.
The firing process may be performed in one stage or may be performed in two or more stages.

The cathode active material produced by the method of the present disclosure may be the cathode active material of the present disclosure described above. That is, details and preferred aspects of the cathode active material produced by the method of the present disclosure may be the same as details and preferred aspects of the cathode active material of the present disclosure described above.

Hereinafter, the present disclosure will be described in more detail with reference to Examples, but the disclosure of the present disclosure is not limited to these Examples.

### Preparation of Cathode Active Material

NiSO₄, CoSO₄ and MnSO₄ were dissolved in ion-exchanged water to obtain a raw material solution having a density of 30 wt %. The molar ratios of Ni, Co and Mn in the raw material dissolving solution were as shown in Table. 1.

An aqueous solution of NH₃ was charged into the reactor, and nitrogen-substituted with stirring. NaOH was then added to the reactor to make the aqueous solution alkaline.

The raw material solution and NH₃ were added dropwise to precipitate Ni, Co and Mn hydroxides while controlling pH in the reactor to be constant. The resulting precipitate was removed by filtration and dispersed in ion-exchanged water. The precipitate dispersed in the ion-exchanged water was filtered and dried at 120° C. for 16 hours to remove moisture, thereby obtaining a transition metal hydroxide as a precursor of the cathode active material.

Lithium hydroxide and a compound containing a dopant element shown in Table 1 were added to the obtained precursor and mixed to obtain a raw material of the cathode active material.

The amount of lithium hydroxide was adjusted so that the amount of lithium per mole sum of the transition-metals (Ni, Co and Mn) in the precursors was 1 mole.
The amount of the compound containing the dopant element was adjusted so that the amount of the dopant elements M1 and M2 relative to the sum of the transition metals (Ni, Co and Mn) and the dopant elements (M1 and M2) in the precursors was 0.01 mol %, respectively.

The raw material of the cathode active material was fired at 700° C. for 3 hours. Thereafter, the obtained calcined product was crushed, and fired at 850° C. for 10 hours. Through the above steps, a cathode active material was obtained.

### Evaluation of Battery Resistance

A cathode active material (88 parts by mass), acetylene black (10 parts by mass) as a conductive material, and polyvinylidene fluoride (2 parts by mass) as a binder were mixed, and the viscosity was adjusted with a solvent to obtain a cathode mixture. The cathode mixture was coated on an aluminum foil and dried at 80° C. for 5 minutes to obtain a cathode.

A laminate type evaluation battery was produced using the obtained cathode, separator (polyethylene microporous film), and an electrode body formed by laminating negative electrodes containing graphite as an active material in this order, and an electrolytic solution.
As the electrolyte solution, a mixed solvent of ethylene carbonate (EC), dimethyl carbonate (DMC), and ethyl methyl carbonate (EMC) in which LiPF₆ (concentration: 1M) was dissolved (the volume ratio of EC/DMC/EMC was 3/4/3) was used.
The charge rate (SOC) of the evaluating batteries was adjusted to 50% and the temperature was adjusted to −10° C. Then, the resistance of the cell was measured from the difference between the voltage and the current during 0.2 C discharging and the voltage and the current 10 seconds after 1 C discharging was started. The obtained measured value was converted into an index when the measured value of the reference battery was set to 100. The results are shown in Table 1.
The reference battery was prepared in the same manner as the above-described evaluation battery except that no dopant element was added to the raw material of the cathode active material, and the firing step was performed in one step at 750° C. for 10 hours.

### Measurement of the Width of the Lithium Layer

The thickness of the lithium-layer of the cathode active material was calculated by Rietveld analysis of the radiation XRD.

Radiated optical XRD was performed using the X-ray powder diffractometer BL5S2 of Aichi Synchrotron Center at measured energies: 15 keV, thresholds: 7.5 to 10 keV, and 2θ-range: 10 to 90 C°. The results are shown in Table 1.
The obtained radiation XRD was subjected to a Rietveld analysis using the application Fullprof for Rietveld analysis.
Specifically, the c-axis length (Cₕ) and the z-coordinate (Z_{oxy}) of oxygen when Chi2 is the smallest value are obtained, and the width (D_{Li}) of the lithium layer is calculated by the following equation.

$$\begin{matrix}{D}_{T M} = 2 \{ ( 1 / 3 ) - {Z}_{oxy} \} {C}_{h} \\ {D}_{L i} = {C}_{h} / 3 - {D}_{TM}\end{matrix}$$

Chi2 is the value of the convergence index obtained by fitting the diffracted data using the least squares method. When the divergence between the diffracted data and the profile fitting is minimal, Chi2 should be minimal.

TABLE 1

| | | | | | | | | | | ionic | | |
|---|---|---|---|---|---|---|---|---|---|---|---|---|
| | | | | dopant elemental M1 | | | dopant elemental M2 | | | radii | Lithium | |
| | | | | | Content | Ion | | Content | Ion | ratio | layer | Resist- |
| | Ratio (mol) | | | | (mol | radius | | (mol | radius | M1/ | width | ance |
| | Ni | Co | Mn | Type | %) | (Å) | Type | %) | (Å) | M2 | (Å) | (%) |
| Standard | 0.8 | 0.1 | 0.1 | — | — | — | — | — | — | — | 2.59 | 100 |
| Com- | 0.8 | 0.1 | 0.1 | Sn | 0.01 | 0.69 | Ta | 0.01 | 0.68 | 1.01 | 2.57 | 101 |
| parative | | | | | | | | | | | | |
| Example | | | | | | | | | | | | |
| 1 | | | | | | | | | | | | |
| Com- | 0.8 | 0.1 | 0.1 | Pr | 0.01 | 0.99 | — | — | — | — | 2.59 | 91 |
| parative | | | | | | | | | | | | |
| Example | | | | | | | | | | | | |
| 2 | | | | | | | | | | | | |
| Example | 0.8 | 0.1 | 0.1 | Y | 0.01 | 0.90 | Ta | 0.01 | 0.68 | 1.32 | 2.64 | 71 |
| 1 | | | | | | | | | | | | |
| Example | 0.8 | 0.1 | 0.1 | Pr | 0.01 | 0.99 | W | 0.01 | 0.62 | 1.60 | 2.65 | 73 |
| 2 | | | | | | | | | | | | |
| Example | 0.8 | 0.1 | 0.1 | La | 0.01 | 1.03 | W | 0.01 | 0.62 | 1.66 | 2.65 | 77 |
| 3 | | | | | | | | | | | | |
| Example | 0.8 | 0.1 | 0.1 | Sr | 0.01 | 1.18 | Ta | 0.01 | 0.68 | 1.74 | 2.62 | 80 |
| 4 | | | | | | | | | | | | |
| Example | 0.8 | 0.1 | 0.1 | Sr | 0.01 | 1.18 | Fe | 0.01 | 0.55 | 2.15 | 2.63 | 81 |
| 5 | | | | | | | | | | | | |
| Example | 0.8 | 0.1 | 0.1 | Sr | 0.01 | 1.18 | Nb | 0.01 | 0.72 | 1.64 | 2.66 | 79 |
| 6 | | | | | | | | | | | | |

As shown in Tables 1, the batteries of Examples 1 to 6 were manufactured using a cathode active material to which a dopant element M1 and a dopant element M2 having an ionic radii ratio of M1/M2 of 1.03 or more and 2.2 or less were added. In the batteries of Examples 1 to 6, the resistance of the battery was reduced as compared with the batteries of Comparative Examples 1 and 2 in which the dopant element added to the cathode active material did not satisfy the above conditions.

As shown in Table 1, the cathode active materials obtained in Examples 1 to 5 have a wider lithium layer than the cathode active materials obtained in Comparative Examples 1 and 2. The above results suggest that the cathode active material includes the dopant element M1 and the dopant element M2 having an ionic radii ratio of M1/M2 of 1.03 or more and 2.2 or less to widen the lithium-layer, thereby reducing the resistivity of the cell.

What is claimed is:

1. A cathode active material, comprising a crystal structure in which a transition metal layer containing nickel, and a lithium layer, are disposed alternatingly, wherein a dopant element M1 and a dopant element M2 with an ionic radii ratio represented by M1/M2 of 1.03 or more and 2.2 or less are included.

2. The cathode active material according to claim 1, wherein the ionic radii ratio of the dopant element M1 and of the dopant element M2 as to nickel are each 0.7 or more and 2.3 or less.

3. The cathode active material according to claim 1, wherein the dopant element M1 and the dopant element M2 are each selected from a group consisting of Sn, Y, Pr, La, Sr, Ta, W, Fe and Nb.

4. A lithium-ion secondary battery, comprising a cathode containing the cathode active material according to claim 1.

5. A method for producing a cathode active material including a crystal structure in which a transition metal layer containing nickel, and a lithium layer, are disposed alternatingly, the method comprising adding, to the cathode active material, a dopant element M1 and a dopant element M2 with an ionic radii ratio represented by M1/M2 of 1.03 or more and 2.2 or less.
